(19) United States
(12) Patent Application Publication
(10) Pub. No.: US 2003/0159051 A1
(43) Pub. Date: Aug. 21, 2003

(54) Method for generating electronic signatures

(76) Inventor: Wilhelm Hollnagel, Malaga (DE)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/239,740

(22) PCT Filed: Mar. 27, 2001
(86) PCT No.: PCT/CH01/00186

(51) Int. Cl. H04L 9/00

(52) U.S. Cl. 713/186; 713/180

(57) ABSTRACT

The method for forming a forgery-proof electronic signature is based on the fact that from data with a specific body feature of the signature-authorised person are combined with data which indicate the presence of the signature-authorised person. From this combination, one forms an electronic signature. Data, which indicate the precence are for example body-heat data or body sound. The forgery-proof electronic signature makes a secure data transfer possible.

The invention relates to a method and to a device for carrying out the method for transmitting an electronic signature, which may only be transmitted with the presence of the authorised person.

The electronic transmission of documents with an electronic signature is effected with various systems via codes which are entered and then transmitted. One assumes that this transmission, as with the “real” signature, has originated from the authorised person. However in any case only the recognition of the transmitting enter location is possible. One may not determine whether the electronic signature has originated from the authorised person, in other words all known and applied systems may not prove the physical existence of the transmitter. There therefore exist the danger of legal insecurity.

The system transmitting the electronic signature may not ascertain an authorisation between the sender and receiver as is the case with the simultaneous presence of a signatory and the person making the signature. The person making the signature must additionally provide identification in front of the notary. With electronic transmission the receiver relies on the transitter being the authorised person without being able to verify this. It is therefore desirable for the electronic signature only to be able to be entered by the authorised person, and only by him. It is therefore not to be possible to transmit a code belonging to this person, which is valid as an electronic signature, without this person being present and doing it himself. If for example a code belonging to this person is transmitted without his presence then this should be recognised as being invalid.

The solution lies in the fact that a code used by a person as a recognition and/or a feature of the person himself is combined with a feature of the physical presence of this person and this information is transmitted as a valid electronic signature.

This is the way envisaged by the invention.

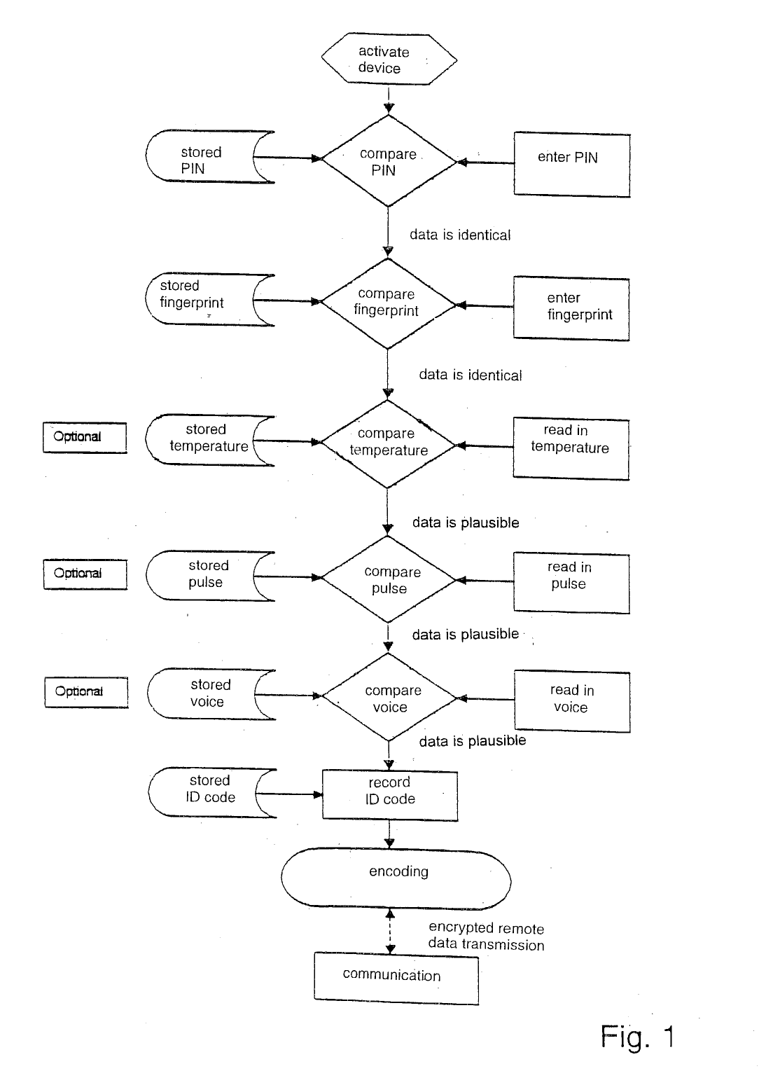

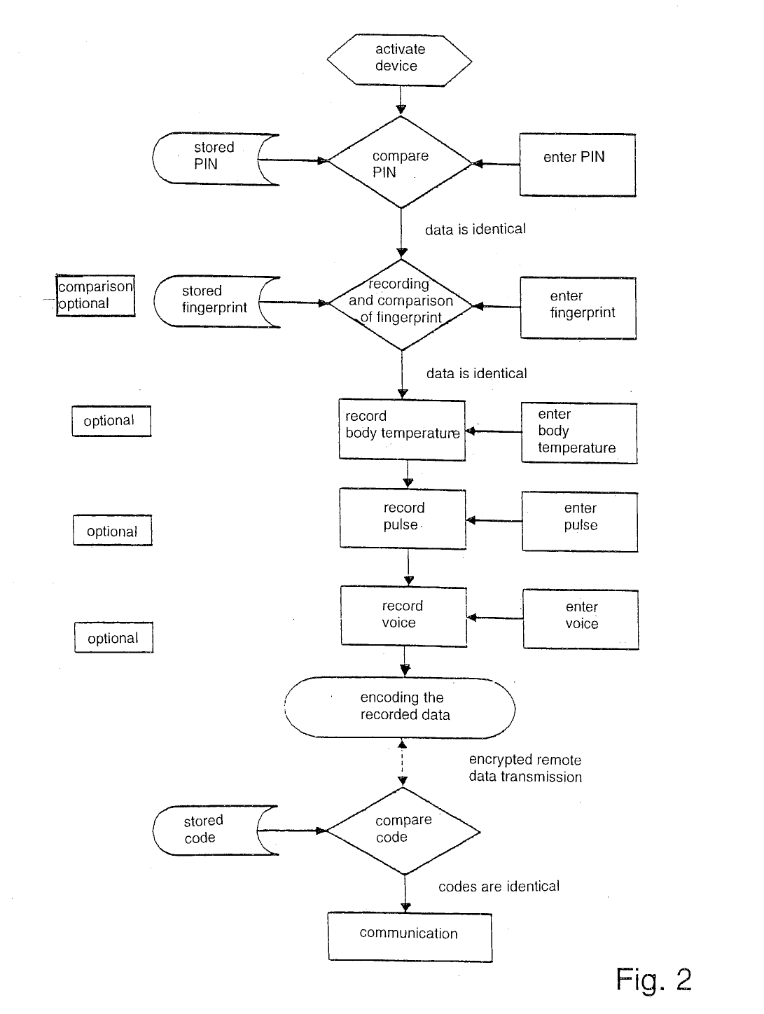

One example of the procedure according to the invention: A person as a sender identifies himself to the system. A secure system must be used for this, which produces a data set which is unmistakable and which may not be produced by forgery. Apart from the access to the system, for example a computer, a handy, a fax or similar means, additionally the data set itself is to be valid and used as an electronic signature. This may be effected for example by the following procedure to be described in further detail by way of FIG. 1, with which the person recognition is evaluated within the input system: The apparatus, thus the computer, the mobile phone, etc. is activated and requests the user to make an electronic signature carried out in the conventional manner, thus the entry of a PIN code. This is compared to the PIN stored in the apparatus. If the entered data is identical to the stored data, the user for example is requested to deposit a fingerprint. The apparatus then one after the other reads the fingerprint, the temperature and where appropriate the pulse and/or voice of the user, wherein the reading-in step in each case is only carried out when the step carried out before it has led to results matching the stored data or made plausible by them. The input of the fingerprint may be effected as a thermal fingerprint which renders the reading-in of the temperature superfluous. When the person recognition has been carried out successfully, in a conventional way and manner the data transmission is then encrypted by way of a stored ID-Code. Another possible way would be to do the evaluation not with the sender but with the receiver, for example the bank or the clearing location (FIG. 2). Also in this way, after the activation of the device, an entered PIN code may be compared to a stored PIN code in a conventional manner. Subsequently one records a fingerprint and accordingly this is compared to a fingerprint stored in the apparatus. The fingerprint data as well as possible additionally recorded data “body temperature”, “pulse”, “voice” (wherein also in this embodiment form the body temperature may also be determined by way of a thermal fingerprint) are encoded and transmitted to the receiver. Here a comparison with the stored code takes place before the access is allowed in the case of an agreement and thus the communication is started. The assignment of the person is documented at the receiver.

There are therefore at least two features within the release information since the one signature is also an electronic signature which must simultanously be present in order to achieve a secure assignment; specifically an identifying code, similar to an address, and/or a feature of this person, as a rule a body feature, as well as a feature that this person was present whilst the information was collected. The identifying code may be variable and contain the remaining details, such as scope of validity, validity duration et cetera. The person feature is to be unique, for example a fingerprint, a retina pattern, an iris image, a characteristic phenomena and likewise. The presence feature is somewhat more difficult to define, in any case these are characteristics such as body heat, voice, pulse noises, muscle rumbling and likewise, which all may be recorded with sensors. Whilst the identification code and the person feature may be stored for a long duration, the presence feature is to be “volatile” thus temporary, as is usual with presence. Since however everything that may be measured may also be stored, it is the case of the correct combination to obtain a stationary presence signal which is temporary and may not be forged. Whilst body heat under certain circumstances may still be simulated, other biological features are not so easy to the point of not being able to be simulated at all. For example the pulse noises are different for various people, even if these are not unambiguous. But already the probability of a matched pulse noise flowing into the combined information when forgeries are attempted is very, very small. Also other variable biological functions are already similar with many people, such as blood groups, but people are divided into a large number of groups.

Thus a combination of an identification code and/or body feature as well as a presence feature, as discussed above, may be seen as information about a person which is almost secure from forgery and to a great extent may be suitable as an electronic signature.

When using mobile telephones the combination may be constructed just as varied, as in conventional internet operations. Additionally with the possible entry of the PIN code the data for example for the data processing at the receiver may be transmitted on two planes (channels) for reasons of security. The fingerprint may for example be converted to a 3D bar code, condensed and subsequently transmitted in the fax mode as a graphical representation. The remaining data sets are alpha-numeric and may for example be conveyed in SMS code or another alphanumeric mode. The data exchange is of course advantageously encrypted. In this manner one achieves a high security for recognition with respect to the transmission partner.

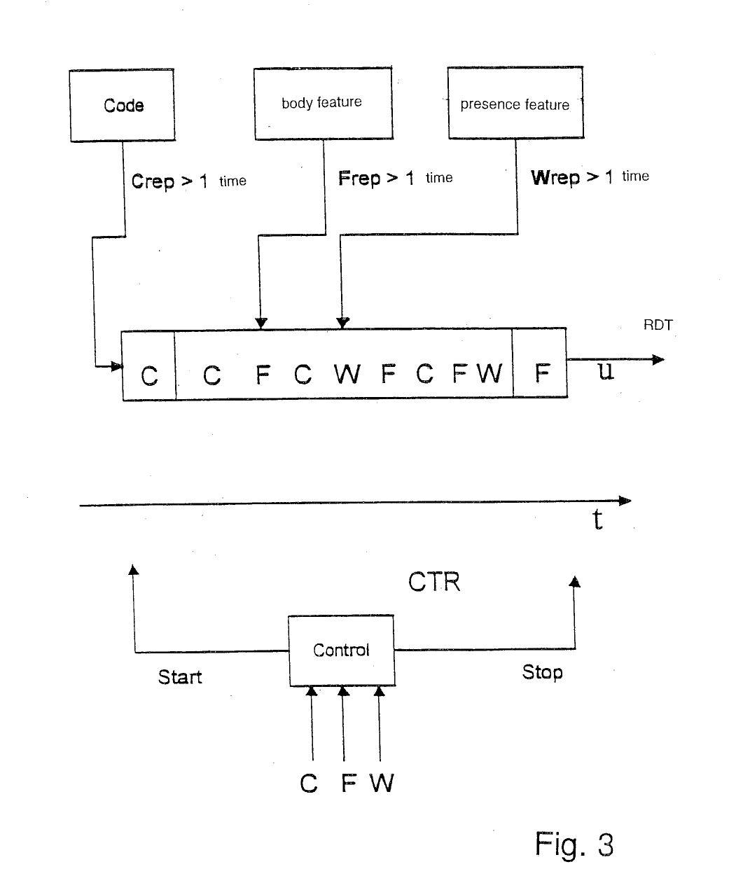

FIG. 3 schematically shows an example of such a procedure. A code transmitter, a fingerprint transmitter for the body feature and a body heat transmitter for the presence feature input their signals C, F, W repetitively and simultaneously for example into a suitably large FIFO memory, here it is a combination sequence FIFO for assembling the data C, F, W into an electronic signature u. The code transmitter, the fingerprint transmitter and the body heat transmitter may be designed as individual components or be integrated into a single apparatus. Also a single locally resolving heat sensor is conceivable which detects a thermal pattern and thus a thermal fingerprint and thus simultaneously determines the data F, W. A controller CTR, responsible for the start and stop of the formation of the data combination on the time axis monitors the data flow for so long until it receives a repetitive data quantity Crep, Frep, Wrep from each transmitter, thus a kind of deja-vue information. With this the required scope of information is present as a data package u for RDT (remote data transmission), but however sequentialised, and as randomly distributed as possible, which one may control. This increases the security from interception and reuse of such an information package as soon as the receiver side has not accepted identical data packages. The probability that a non-identical data package is legitimately transmitted is low and in this rare case leads to a rejection and the required new transmission.

Specific body sounds may also be compiled for the presence control as a presence feature in place of body heat. One knows of the pulse measurement on the wrist, earlobes, finger and everywhere where a pulse is present that the sounds of the flowing blood and above all things the rumbling sounds of muscles superimpose on weak pulse signals and interfer with these considerably. These noises are semi-specific, which is to say are similar with groups of humans. It is however less probable for the semi-specific presence data which is detected and suitably evaluated over a short period of time and added to the other specific data to be able to be easily forged. If for example one combines a fingerpint with a sound sensor instead of a heat sensor, one has more specific presence information which may also be evaluated more specifically. When recording the pattern of the iris of a person as a presence feature the oscillation of the eye, the so-called jitter (approx. 20 ms) may be used.

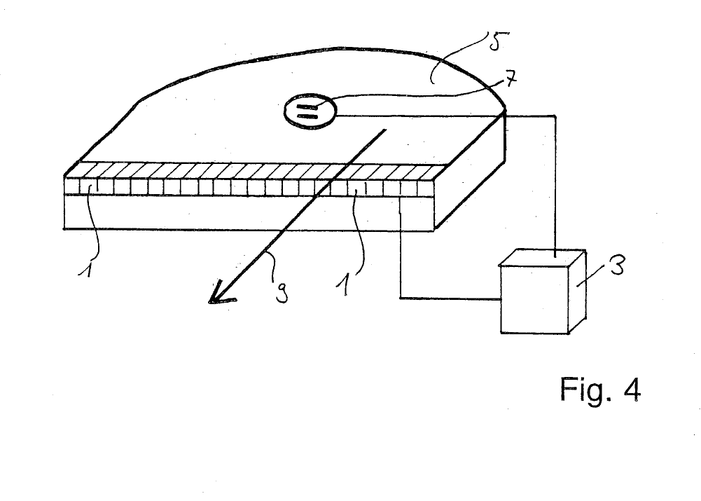

A preferred embodiment of the invention is now further described by way of the very schematic FIG. 4. This embodiment form uses the combination of a thermal fingerprint with the evaluation of the sound data. The fingerprint scanner for example comprises a row of thermal sensors 1. Only a few sensors have been shown for reasons of a better overview. It is however to be understood that the distance of the individual sensors must be of the size order of the distance between two neighbouring fingerprint lines or smaller. The sensors are connected to an evaluation unit 3. There of course exists the possibility of integrating the evaluation unit and sensors into a single chip. In this context one refers to the extensive literature on thermal sensors and integrated sensors. Furthermore the fingerprint scanner comprises an operating surface 5 which for example is shaped ergonomically for receiving a finger. A microphone may be arranged below the operating surface 5 or below microphone openings 7 which are possibly present in this. This too is connected to the evaluation unit.

A thermal fingerprint is thus detected in that a finger is slowly pulled over the sensor row, from which there results a 2D scan of the finger. The fine temperature differences at the sensor are at the same time sufficient for a contrast signal, from which one may conclude the finger topography.

The thermal fingerprint already per se permits a dead/living recognition. If the finger is cold there are no temperature differences, the fingerpint scanner emits a zero signal. The microphone which is optionally preconnected to the fingerpint increases the reliability of the dead/living recognition and permits the evaluation of a further characteristic recognition feature. When applying the finger firstly the pulse and the flowing noises are registered. The noises are led to a data processing unit of the evaluation unit 3 by way of an A/D converter which is for example present in the evaluation unit 3. Here a Fourier analysis is carried out. A frequency energy spectrum arises. From this characteristics (formants) are filtered out. With this an assignmenet of the spectrum data to characetristic life data may be gained. Subsequently the finger is pulled in the direction of the arrow 9 over the row of thermal sensors and a 2D fingerprint is determined.

The scanner for example has a stored scanner ID which by way of evaluation means is non-volatile and may be overwritten. This is a code which is appended to each set of data transferred from the scanner to the device to which it is connected.

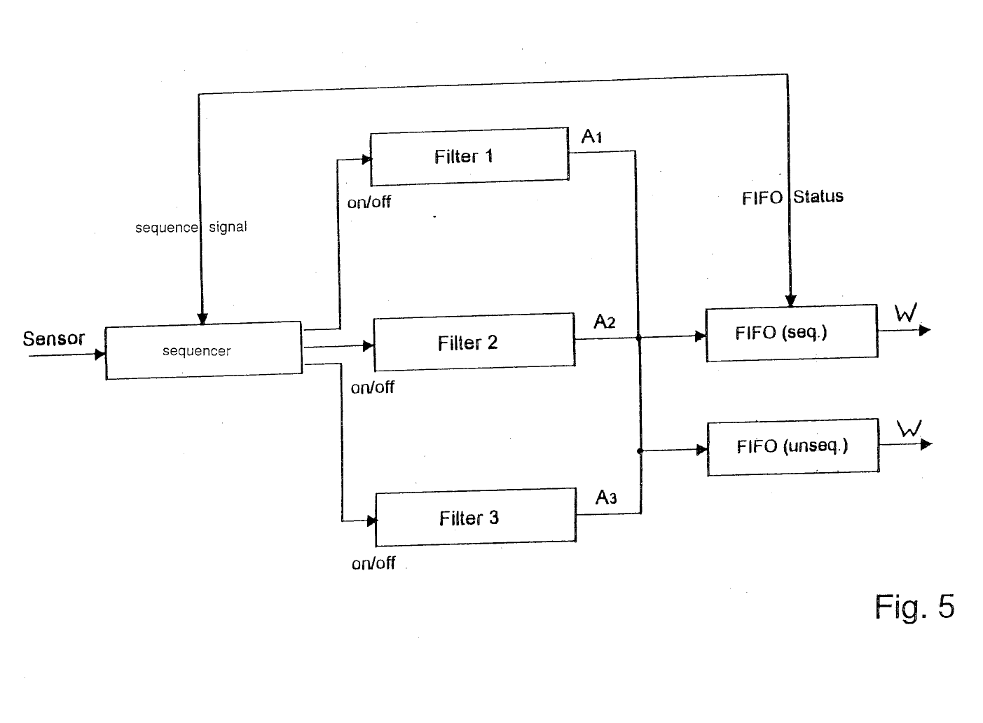

FIG. 5 shows another example of how a signal sequence from a sensor, for example from a sound sensor such as the microphone according to FIG. 4, a presence feature W for feeding into the combination sequence FIFO, may be processed according to FIG. 3. The signal from the microphone is led to a sequencer for example a MUX, to whose outputs there are connected a few filters. Each filter lets though only one characteristic frequency band A1, A2, A3 and mixes these depending on sequence in a sequence FIFO from whose output the signal W may be taken. A further FIFO is drawn parallel to this, from which selectively an unsequenced data series W may be taken.

The data package for transmitting to the data remote transmission (DRT) now contains a sequence of presence features which on the one hand may be subject to the random principle and on the other hand assigned to the person group. The variety of the group is not small if for example it is the case of noises from the fingers, since there are female hands which are strong or weak, male hands which are strong or weak, slim fingers and thick fingers, well circulated and less well circulated fingers, thick or thin skin, good hear pump functioning and less well etc. etc. All this contributes to the ability to differentiate.

The method according to the invention may be applied for example in the changing business of a bank or a clearing location with customers. Transactions are only carried out when the forgery-secure electronic signature has been checked. One may therefore rule out for example that unauthorised persons from a mobile telephone may carry out money transactions in the name of the owner of the mobile telephone.

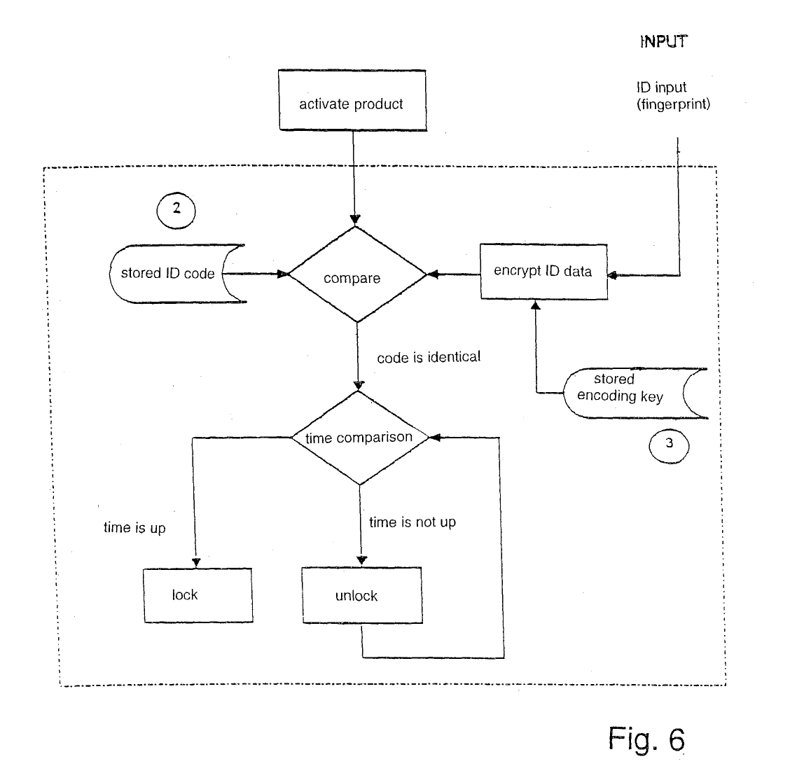

In the following a further embodiment of the invention is yet described which is to secure the access to a product which falls under special protection, for example a weapon. As is shown in FIG. 6 after the activation of the product the encrypting of the electronic signature (ID data, fingerprint) is carried out by way of an encrypting key which is deposited in the product itself. A release of the product is effected only when the encrypted electronic signature corresponds to an identifiation code (deposited ID code).

After a certain time the product is automatically locked again. The release is effected only after the renewed entering of the electronic signature. In place of the release/locking of a weapon of course a release of any other product or service with limited availability is also conceivable, for example the ability to operate money transactions.

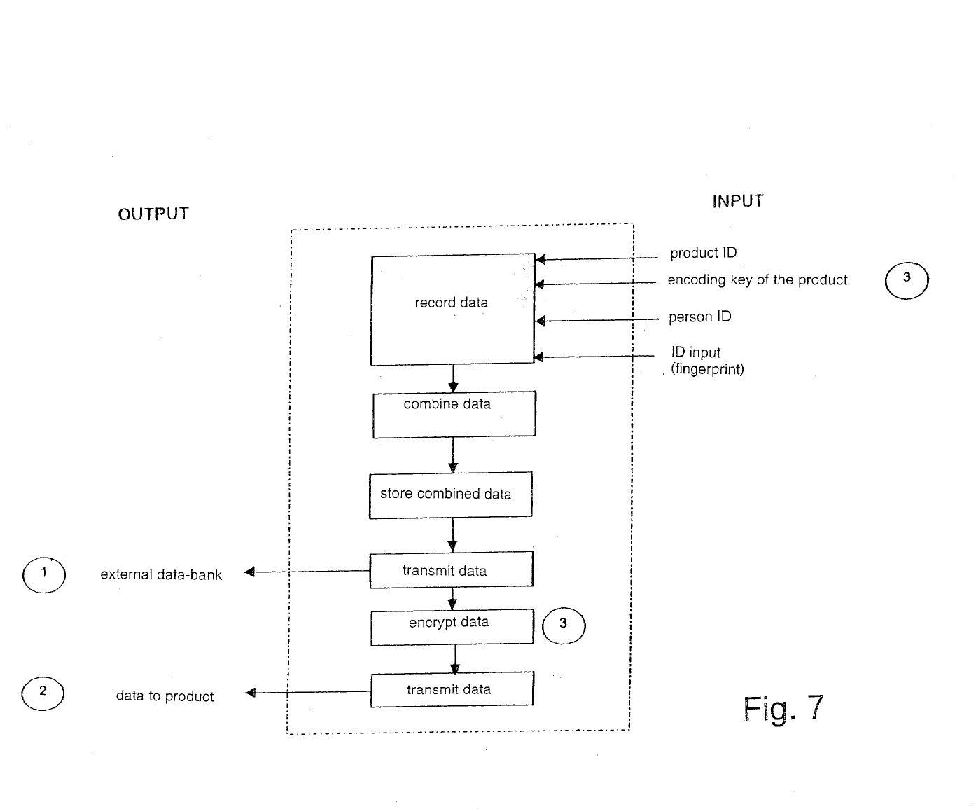

In FIG. 7 there is shown the data flow when initialising the product, for example on purchasing a weapon. The identity of the puchaser is advantageously likewise checked with the help of the method according to the invention and a corresponding identity card (person ID). Subsequently with the product ID, the encoding key of the product, the person ID and the fingerprint data, by way of combining and encrypting, the comparison to the used identification code (data on product) is produced. As is likewise shown in FIG. 7, it is possible for the user-specific data (including electronic fingerprint verified with the identity) which is not yet encrypted, to be transmitted to an external data bank, for example of the weapons dealer. Thus when required, by way of the product identification one may check who has used the product, wherein the identification becomes forgery-proof by way of the method according to the invention. The encoding key of the product according to the figure may be recorded together with the product ID data and person ID data. Alternatively this may also be present in an external computer centre assigned to the data bank. In this case the data after encrypting by the computer centre is transmitted to the seller of the product, for example the weapons dealer and applied in the product. The identification code subsequently may not be changed or only by authorised persons with suitable means and with the key which is present only at the computer centre outside the product. By way of this the identification code is unique and characteristic for the product as well as the user and signatory. This embodiment of the invention thus provides an enclosed identification system. An identification code stored on another product, for example on an identity card (person ID) and likewise produced with the electronic signature according to the invention is never identical to the identification code of the product. As a result it may never be misused to circumvent product protection, for example by entering this identification code instead of the encrypted electronic signature.

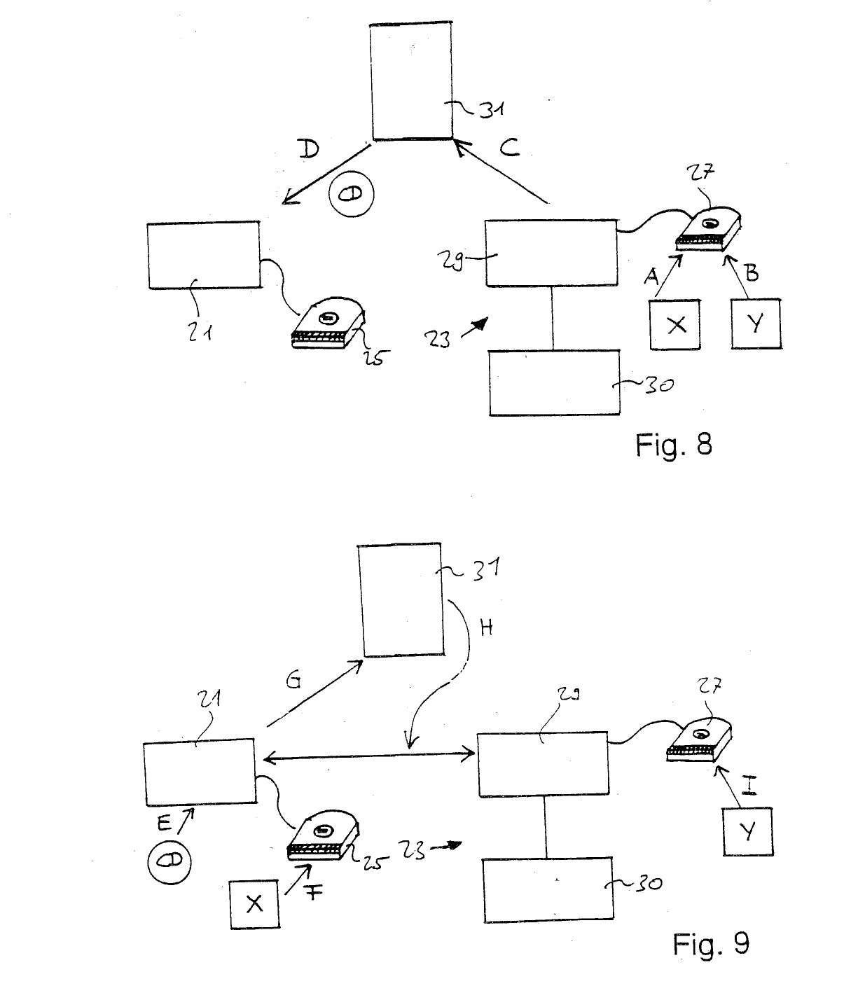

In the following a method for the access control to computer software for the communication between a client and contractor is further described by way of FIGS. 8 and 9, this method being based on the method for forming an electronic signature and develops this further. In the following description as an example it is assumed that the software-data memory is a CD. It is however to be understood that the method may analogously be applied with other known memories and ones which are yet to be developed, for example on chip cards, floppy disks, DVDs, other optical, magnet-optic or magnetic memory media or on data transmitted online.

At the client or at the contractor the computer systems 21 and 23 are equipped with sensors 25 and 27 respectively which may detect the individual body features of those persons who are to obtain access authorisation. The sensors are suitable for carrying out a dead/living identification. The scanner may not be deceived by way of photographic methods. In order to ensure this simultaneously to the reading-in of the body features (the biometric data) a dead/living identification is yet carried out. A secured server system 29 is installed at the client as part of a computer system 23 which stores the specific data of clients in a data bank. These consists of the usual PIN, the data ID with which the client obtains access as well as his fingerprint scans (FPS). For example several scans per person are stored so that in the case of an injury to one finger, an operation of the system remains possible. This installation forms the interface to the server system 30 of the contractor. If the client is for example a bank which as a client offers transactions for customers which are to be carried out electronically, this server system is the usual server system of the bank.

Apart from several FPSs by way of which a release signal may be activated, one may also envisage storing yet a further fingerprint scan, for example of a selected finger. If the user lets this print of the finger to be read, at another location, an alarm is activated for example at the central control or at police. This alarm however is not noticed at the location of the user. This type of alarm activation is made available for the case in which the user is forced under the threat of violence into reading in his data. He may then seemingly carry out his transactions. These however are not really carried out and at the same time measures for combatting the criminal action are carried out in the background. A combination of read-ins may serve for activating the alarm in place of the selected fingerprint scan (“alarm finger”).

A software certification installation (SCI) 31 is separated spacially from the contractor. This is constructed just as clearly as with the server system 29 of the contractor 29. This installation 31 contains access software and records the biometric data (e.g. fingerprint scan) of the persons authorised at the contractor, their PINs, the CD-IDs and their user password in a data bank. Additionally where appropriate for each client and/or contractor an identification code of the device for reading in the biometric data and/or presence data (scanner ID) is stored. The program CDs for the person authorised at the contractor (in the following authorised person) and the client are issued from this location. Each CD issued by the SCI is unique. If the contracor is a bank acording to the above example, with regard to the electronic transactions it assumes the function of a bank card. The authorised person is then the banker who looks after the client. A customer password given individually by the contractor to the client is however not stored on the CD.

In FIG. 8 there are shown the steps carried out when setting up the access. The biometric data of the client (X) are read in (step A) at the contractor, for example in the bank. For the purpose of verification, the biometric data of the authorised person (Y) are likewise read in (step B). The data, preferably encrypted, are led to the SCI (step C) by way of which the biometric data is verified with respect to the SCI. With a positive recognition of the biometric data of the authorised person a customer CD is set up and delivered to the contractor (step D). The desired program is stored on the customer CD, said program however where appropriate may not function as such on account of the absence of smaller but essential program parts. Furthermore the biometric data of the client is stored. For reasons of security it may however be recommended to do away with this storage and not to store this data externally at the client but only at the SCI.

FIG. 9 shows the steps which are carried out when applying the software. On application the customer applies his CD into his computer (step E) and “signs” his biometric data by verification, thus for example by carrying out a thermal fingerpint scan (step F). Additionally for example the entering of the PIN may be effected in his computer. If according to a first variant, the biometric data of the client is stored on CD, a comparison is effected directly at the client. On agreement, via the internet for example one sets up a connection to the SCI (step G). According to a second variant in any case a connection to the SCI is set up and a comparison between read-in and stored biometric data is carred out at this. Subsequently an encrypted data exchange is effected via this connection. At the same time under certain circumstances one may use a key which is dependent on time. With this data exchange an agreement of the PIN, the data ID and the biometric data (signature) may be additionally checked again. An alarm is activated if there is no agreement. If however there is agreement, the transfer of missing software parts to the client and the verification with respect to the server of the contractor (step H) is for example carried out, whereupon a connection between the server of the contractor and the computer of the client is created. The construction of the connection for example sets a virtual clock in action with the start point server time into operation. Optionally once again a matching between biometric as well as presence data and stored data is once again carried out whilst using another key. The second verification via the communication line between the client and the contractor by way of redundance adds an additional security element. The SCI in the example described here is cut off from communication after this procedure. In this manner it may be ensured that data which is relevant to the data exchange between the client and contractor and are possibly to be handled with discretion, for example data relevant to the bank, may never be led through the SCI. The customer password is also not led via the SCI. The virtual clock activates a warning signal on exceeding a certain time and/or cuts the connection.

At any time in the SCI one may block either all of the connections or selectively in the case that an authorised person is to lose his authorisation. A manipulation within the company of the contractor may therefore be prevented.

After checking the verification in the SCI the switching through to the known server systems using a data exchange system according to the state of the art is carried out in the computer system of the contractor. The contractor, for example a bank, thus has the possibility of preventing the access of unauthorised persons to the existing data exchange system.

For activating the contractor computer system the verification is required by an access-authorised person (Y) (step 1) at predetermined intervals. With this verification, the contractor computer system is released for a limited time by the SCI. The release is stored in a volatile memory. An authorised person when transfering to a successor must log out. His “control time” is protocolled. One may therefore trace which authorised person has obtained a certain client access authorisation and who is responsible for the activation. This aspect may for example be important, for example with regard to duty regulation which are to be particularly expected in the banking sector.

If the logging out is missed, then when desired a new release without previous logging out may demand the verification of two authorised pesons.

One may also envisage levying the license fee according to the degree of use, for example in that the communication between the client and the contractor and/or the communication between the client and the SCI takes place via a telephone line which is charged for.

In the description of the following described embodiment example, one is again reminded of application in the banking sector. Here a secure data transfer is absolutely essential. Furthermore the above cited embodiment form may ensure a verification also of an authorised person of the bank and thus render impossible misuse by bank personnel. In an analogous manner the described method may also be used in business between the sales location, customers and credit card or debit card companies, on issuing traveller tickets, in particular in airline travel (ticketing), for sales agreements, for pass controls, in business between the doctor and the hospital, patient and health insurance company, etc. Furthermore further methods based on determining an electronic signature are indeed also conceivable. Thus for example by way of the central certification location one may issue a verification data set for verifying signatures for any data exchange. Examples of such infinite data sets are e-mails and fax documents exchanged between partners. A verification data set may where appropriate be integrated directly into e-mail programs, fax software, etc. and be used by way of these automatically for verifying the identity of the sender.

In the example of fax transmission an electronic signature which has been determined once according to the previously described method is appended to each data package by a suitably programmed fax apparatus. With fax apparatus according to the state of the art one data package for example corresponds to one side; in the future also other fragmentations would definately also be possible. The receiving fax apparatus for example with a connection which has been declared as safe only prints data packages with a recognised electronic signature.

For example one may apply the following method for initialising a secure data exchange between two partners: The two partners go to the certification location where according to each case they must personally identify themselves. Then biometric data and presence data (for example pulse sounds) are detected. Subsequently this data is subjected to a non-reversible, specific first and second encrypting algorithm and stored on a memory envisaged for the other partner.

If a partner then wishes to send the other a document (e-mail, fax etc.) as a signature he has to enter his biometric and presence data and transmit this with the document to the partner. For this he subjects it firstly to an encryption. The transmission is effected with an additional, preferably assymetrical transmission encryption (analog to PGP) with a key which changes with each transmission. After transmission to the other partner the reverse algorithm of the transmission encryption and subsequently the second irreversible encryption algorithm is applied, whereupon a comparison of the electronic signature with the stored data is carried out. In this manner the partner may securely verify whether the received document has been signed by the other partner. Furthermore one rules out the case in which one of the partners with respect to a third party passes himself off as the other since the first and second irreversible encryption are identical. When required this system may be yet extended by the possibility that a release of the connection is only effected via the central certification location. The transmission with constantly changing transmission keys prevents a third party form passing himself off as one of the partners.

Alternatively to this method, a secure fax connection may always run via a central certification location which then to each fax doccument attaches a visible or invisible stamp of authenticity with which one confirms the identity of the sender.

Additionally to the above measures in all described cases one may further make the input of a conventional PIN code for identifying users or as software ID as a condition for an exchange of data. An optional additional inclusion of a code for identifying the apparatus for reading in the biometric and/or presence data may be used for unambigously identifying from where a data set has been sent.

The exchange of electronic signatures described by way of examples is effected generally in an encrypted manner. It is however to be briefly described how the security in combination with the above methods may be increased even further using conventional encrypting formulations.

The memory, thus the CD, chipcard, diskette, DVD or others or the software stored on an apparatus is provided with a software ID. The apparatus for reading in biometric and/or presence information has an unambiguous identification code (“scanner ID”). The transmission key is determined on the basis of the scanner ID, the time and possibly additionally on account of the software ID and/or the user ID. The determination of the key from the time and the ID or IDs is effected preferably by way of a preferably non-reversible algorithm, for example according to the state of the art.

A further example for a method according to the invention is decribed hereinafter. This example is based on the fact that with a server system in a program run the connection to several users is created with which at least one participant is known in his identity with repspect to the other participants.

Examples of several users according to this example are a customer, a supplier and a bank, wherein a delivery of goods is to be made or a service is to be carried out. Examples of suppliers are a store shop which delivers a product or a software house which offers a download. One may set up multilateral connections via a server. With this connection the presence of at least one participant, for example a customer is verified according to the previously described method. In the case of the request of a service the supplier by way of a third party, for example the bank of the customer, obtains the verification on the agreement to pay (for example via an account security to the amount of the sum of the order). If the supplier confines the service then the payment is effected. If the payment is due on delivery, then this may be confirmed by the customer on receipt at an external terminal with the apparatus for reading in biometric and/or presence data or the supplier confirms the delivery in that he identifies himself with respect to the system in combination with the delivery procedure which then triggers the payment procedure. All participants with such a transaction are for example known as persons present.

One may realise an analogous sequence if a document with payment obligation and transfer of rights is to trigger a payment procedure at a financial institution (the purchase of a right). In this case the seller, buyer and where appropriate one or more notaries must verify their presence and the link to the document knowing that after execution a payment procedure is successfully carried out.

1. A method for forming a forgery-proof electronic signature, characterised in that from data (F) with a specific body feature of the signature-authorised person as well as data (W) which indicate the presence of the signature-authorised person, one forms a data combination (u), said data combination embodying the corresponding electronic signature.

2. A method according to claim 1, characterised in that for forming the data combination (u) one uses additional data (C) for an identification code.

3. A method according to claim 2, characterised in that the data for the identification code (C) contain an alphanumeric series of characters.

4. A method according to one of the preceding claims, characterised in that the data (F) with the specific body feature are those of a fingerprint and that the data (W) for the presence of a signature-authorised person originate at least partly from the body heat of his fingerprint.

5. A method according to one of the preceding claims, characterised in that the data (W) for the presence of a signature-authorised person originate at least partly from the body sound of his finger.

6. A method according to one of the claims 1 to 3, characterised in that the data (F) with the specific body feature are those of the eye iris and that the data (W) for the presence of a signature-authorised person originate from the pupil tremors of his eye.

7. A method according to one of the preceding claims, characterised in that the data (F) for the specific body feature and the data (W) for the presence of a signature-authorised person are sequentially read into a memory and this complete sequence is used as an electronic signature.

8. A method according to claim 2 or 3, characterised in that the data for the identification code (C) and the data (F) for the specific body feature and the data (W) for the presence of a signature-authorised person are read into a memory sequentially in a manner such that the sequence parts are stringed together according to random principle and the complete sequence is used as an electronic signature.

9. A device for setting up a forgery-proof electronic signature with the involvement of biometric data, characterised by a first means (F) which registers a body feature and prepares data from this and a second means (W) which registers the presence of a person from which one has recorded the body feature and a third means (CTR) which controls the output of information of the first two means, and a memory for recording and outputting the data from the information stored in a controlled manner.

10. A device according to claim 9, characterised by means (C) for preparing an alphanumeric code.

11. A device according to claim 9 or 10, characterised in that to the second means (W) which indicate the presence of a person from whom the body feature has been recorded one connects one or more means (A1, A2, A3) specifying the signals and/or the data, and the signals at the output of this or these are grouped together into a data sequence.

12. A device according to claim 9, characterised in that the first means comprises a row of thermal sensors (1) for recording a thermal fingerprint as well as evaluation means (3), and that the second means comprises a microphone.

13. A device according to claim 12, characterised in that the second means additionally comprises processor means for determining a Fourier spectrum of pulse sounds.

14. A method for transferring data between a client (X) and a contractor (Y) with the help of a communication connection, characterised by the following steps:
a) creating a first connection between the client and a central certification location (31)
b) determining body-specific data (F) and data which characterise (W) the presence of the client (X),
c) forming a data combination (u) as an electronic signature,
d) transferring this data combination (u) to the central certification location via the first connection
e) verifying the identity of the client by the central certification location by way of the data combination (u)
f) creating a second connection between the central certification location (31) and the contractor (X)
g) creating a third connection between the client and the contractor, and cancelling the first and second connection
h) data exchange between the client and the contractor via the third connection.

15. A method according to claim 14, characterised in that simultaneously to step g) or after step g) one creates a verification data set which contains an identification of the client, for example the data combination (u) as his electronic signature, as well as an identification of an access-authorised person of the contractor, for the electronic signature of this.

16. A method according to claim 14 or 15, characterised in that in step d) additionally a code identifying the means for determining the body-specific data (F) and/or the means for determining the data (W) characterising the presence is transmitted.

17. A method according to one of the claims 14 to 16, characterised in that the data in step d) is transmitted in an encrypted manner, wherein one uses a time-dependent key.
